(19) United States
(12) Patent Application Publication
(10) Pub. No.: US 2017/0059028 A1
(43) Pub. Date: Mar. 2, 2017

(54) TORSIONAL VIBRATION DAMPERS HAVING A HUB WITH SPOKES ACTING AS A SECOND SPRING IN SERIES WITH AN ELASTOMERIC MEMBER

(71) Applicant: Suhale Manzoor, Plymouth, MI (US)

(72) Inventor: Suhale Manzoor, Plymouth, MI (US)

(73) Assignee: Dayco IP Holdings, LLC, Troy, MI (US)

(21) Appl. No.: 15/248,727

(22) Filed: Aug. 26, 2016

Related U.S. Application Data
(60) Provisional application No. 62/210,688, filed on Aug. 27, 2015.

(51) Int. Cl. F16H 55/40

(52) U.S. Cl. CPC F16H 55/40; F16H 2055/366

(57) ABSTRACT

Torsional vibration dampers for rotating shafts are disclosed that have a hub or a hub portion of a pulley-hub monolithic body that has an innermost sleeve defining a bore, an outermost ring concentric with and spaced radially outward from the innermost sleeve, and a plurality of spokes connecting the innermost sleeve to the outermost ring that each have torsional flexibility to act as a first spring to attenuate torsional vibrations. The dampers include an elastomeric member positioned concentrically against the outermost ring or the innermost sleeve of the hub, where the elastomeric member acts as a second spring to attenuate torsional vibrations, and an inertia member positioned concentrically against the elastomeric member, which places the first spring and second spring in series. The dampers may be crankshaft, driveline, or direct drive dampers, and the equivalent spring rate for the first and second springs is governed by the elastomeric member.

### RELATED APPLICATIONS

This application claims the benefit of U.S. Provisional Application No. 62/210,688, filed Aug. 27, 2015, the entirety of which is herein incorporated by reference.

### FIELD OF THE INVENTION

The present invention relates to torsional vibration dampers, including crankshaft dampers, driveline dampers, and direct drive dampers, more particularly each of which have a hub with spokes having torsional flexibility as a first spring and an elastomeric member as a second spring damper system.

### BACKGROUND OF THE INVENTION

Torsional vibration dampers (TVDs) are employed extensively in internal combustion engines to reduce torsional vibrations delivered to rotatable shafts. The torsional vibrations may be of considerable amplitude, and, if not abated, can potentially damage gears or similar structures attached to the rotatable shaft and cause fatigue failure of the rotatable shaft.

Torsional vibration dampers convert the kinetic vibrational energy by dissipating it to thermal energy as a result of damping. The absorption of the vibrational energy lowers the strength requirements of the rotatable shaft and thereby lowers the required weight of the shaft. The torsional vibration damper also has a direct effect on inhibiting vibration of nearby components of the internal combustion engine that would be affected by the vibration.

The simplest insertion style torsional vibration damper has three components, a hub that allows the damper to be rigidly connected to the source of the vibration, an inertia ring, and an elastomeric member between the hub and the inertia ring. The elastomeric member provides the spring dashpot system for the damper. The hub and the inertia ring are manufactured individually and machined before the elastomer is inserted by force into the gap that is present between the hub and the inertia ring. The elastomer is compressed and exerts pressure between the metallic surfaces of the inertia ring and hub, holding the assembly together.

For any mechanical system, the torsional natural frequency depends upon the inertia, torsional stiffness and damping of the system. In the traditional torsional vibration damper, the inertia is provided by the inertia ring, while the damping and torsional stiffness are provided by the elastomeric member. This otherwise implies that the hub is, in fact, a rigid attachment that does not provide any significant help to the damping system except to provide a rigid means of connection to the rotating component of the vehicle. Thus, the damping in these traditional torsional vibration dampers, by definition, is fully a result of the elastomeric member. There is a need for the hub to help in the damping, as well as weigh less.

Accordingly, new torsional vibration dampers that accomplish both are needed.

### SUMMARY

In one aspect, torsional vibration dampers for a rotating shaft are disclosed that have a hub having an innermost sleeve defining a bore, an outermost ring concentric with and spaced radially outward from the innermost sleeve, and a plurality of spokes connecting the innermost sleeve to the outermost ring, which have torsional flexibility to act as a first spring to attenuate torsional vibrations. The TVDs have an elastomeric member positioned concentrically against the outermost ring or the innermost sleeve of the hub, which acts as a second spring to attenuate torsional vibrations, and an inertia member positioned concentrically against the elastomeric member. This operably couples the inertia member to the hub for rotation together with the first spring (plurality of spokes) and second spring (elastomeric member) in series. The equivalent spring rate (k_{eq}) for the first and second springs in series is governed by the elastomeric member, which has a thickness of about 2 mm to about 10 mm.

In all aspects, the plurality of spokes define a plurality of labyrinth windows axially through the hub, and have a plurality of first partial spokes extending radially outward from the innermost sleeve and a plurality of partial spokes extending radially inward from the outermost ring, which are connected to one another by a continuous serpentine web.

In some embodiments, the plurality of spokes comprise a first plurality of partial spokes extending from the innermost sleeve toward the outermost ring of the hub, and each comprise a generally T-shaped member interconnected to one another by a generally annular connecting member. The plurality of spokes also includes a second plurality of partial spokes extending from the outermost ring of the hub toward the innermost sleeve, which each have a generally T-shaped member interconnected with the T-shaped members of the first plurality of partial spokes by the generally annular connecting member, for example, a serpentine web.

Optionally, one or both of the outermost ring or the innermost sleeve of the hub and a radially inward or outward surface of the inertia member have an annular recess concentric about an axis of rotation of the hub in which the elastomeric member is seated. If both have an annular recess, then one of the annular recesses will be deeper than the other. In these embodiments, the elastomeric member has a first width that is substantially similar to a second width of the surface of the hub upon which the elastomeric member will be seated, and is press-fit between the hub and the inertia member or is mold bonded to one of the hub or inertia member. In another of these embodiments, the elastomeric member comprises a plurality of elastomeric members each having a first width that is less than a second width of the surface of the hub upon which the elastomeric member will be seated, concentric about an axis of rotation of the hub and positioned a distance apart in an axial direction from one another or abutting against an adjacent elastomeric member.

In some embodiments, the inertia member has an outermost belt-engaging surface, and the bore of the hub is configured to receive a crankshaft.

In other embodiment, the bore of the hub is configured to receive a driveline shaft.

In another aspect, direct drive torsional vibration dampers for a rotating shaft are disclosed that have a pulley-hub monolithic body comprising a pulley portion and a hub portion. The hub portion includes the features discussed above for the other TVDS, such as an innermost sleeve defining a bore configured to receive a shaft, an outermost ring concentric with and spaced radially outward from the innermost sleeve, and a plurality of spokes connecting the innermost sleeve to the outermost ring where the plurality of spokes each have torsional flexibility to act as a first spring to attenuate torsional vibrations. The TVDs have a first elastomeric member seated against the pulley portion of the pulley-hub monolithic body and held thereagainst for rotation therewith by an inertia member connected to the pulley portion. Like the previously described TVDS, the first elastomeric member acts as a second spring to attenuate torsional vibrations in series with the first spring (plurality of spokes of the hub portion). The equivalent spring rate (k_{eq}) for the first and second springs in series is governed by the elastomeric member.

In all aspects, the plurality of spokes define a plurality of labyrinth windows axially through the hub.

In another aspect, a front end accessory drive system is disclosed that includes any one of these torsional vibration dampers. The TVD may be on the crankshaft or may be on the driveline.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view of components in a front end accessory drive.

FIG. 2 is an isometric view, in a partial cross-section, of one embodiment of a torsional vibration damper having a hub with flexible spokes having torsional flexibility as a first spring and an elastomeric member as a second spring, in series.

FIG. 3 is a schematic illustration of a spring diagram for the torsional vibration damper of FIG. 1.

FIG. 4 is a top, plan view of a second embodiment of a hub for a torsional vibration damper, such as the torsional vibration damper of FIG. 1.

FIG. 5 is a top, plan view of a third embodiment of a hub for a torsional vibration damper, such as the torsional vibration damper of FIG. 1.

FIG. 6 is a top, plan view of a fourth embodiment of a hub for a torsional vibration damper, such as the torsional vibration damper of FIG. 1.

FIG. 7 is a partial longitudinal sectional view of an embodiment of a torsional vibration damper showing one configuration for the elastomeric member.

FIG. 8 is a partial longitudinal sectional view of another embodiment of a torsional vibration damper showing another configuration for the elastomeric member.

FIG. 9 is a partial longitudinal sectional view of yet another embodiment of a torsional vibration damper showing yet another configuration for the elastomeric member.

FIG. 10 is a partial longitudinal sectional view of yet another embodiment of a torsional vibration damper showing yet another configuration for the elastomeric member.

FIG. 11 is a partial longitudinal sectional view of yet another embodiment of a torsional vibration damper showing yet another configuration for the elastomeric member.

FIG. 12 is a partial longitudinal sectional view of yet another embodiment of a torsional vibration damper showing yet another configuration for the elastomeric member.

FIG. 13 is a partial longitudinal sectional view of yet another embodiment of a torsional vibration damper showing yet another configuration for the elastomeric member.

FIG. 14 is a partial longitudinal sectional view of yet another embodiment of a torsional vibration damper showing yet another configuration for the elastomeric member.

FIG. 15A is a 3D plot of a finite element model of the torsional vibration damper of FIG. 1 showing that the first mode is torsional.

FIG. 15B is a 3D plot of a finite element model of the torsional vibration damper of FIG. 1 showing that the second mode is axial and there is adequate modal separation between the frequencies.

FIG. 16 is an isometric view, in a partial cross-section, of one embodiment of a driveline torsional vibration damper having a hub with flexible spokes having torsional flexibility as a first spring and an elastomeric member as a second spring, in series.

FIG. 17 is a partial, perspective, longitudinal cross-sectional view of one embodiment of a direct drive torsional vibration damper having a hub with flexible spokes having torsional flexibility as a first spring in series with a plurality of elastomeric members as second springs.

FIG. 18 is a partial, perspective, longitudinal cross-sectional view of another embodiment of a direct drive torsional vibration damper having a hub with flexible spokes having torsional flexibility as a first spring in series with a plurality of elastomeric members as second springs.

FIG. 19 is a longitudinal cross-section of half of another embodiment of a direct drive torsional vibration damper.

### DETAILED DESCRIPTION

The following detailed description will illustrate the general principles of the invention, examples of which are additionally illustrated in the accompanying drawings. In the drawings, like reference numbers indicate identical or functionally similar elements.

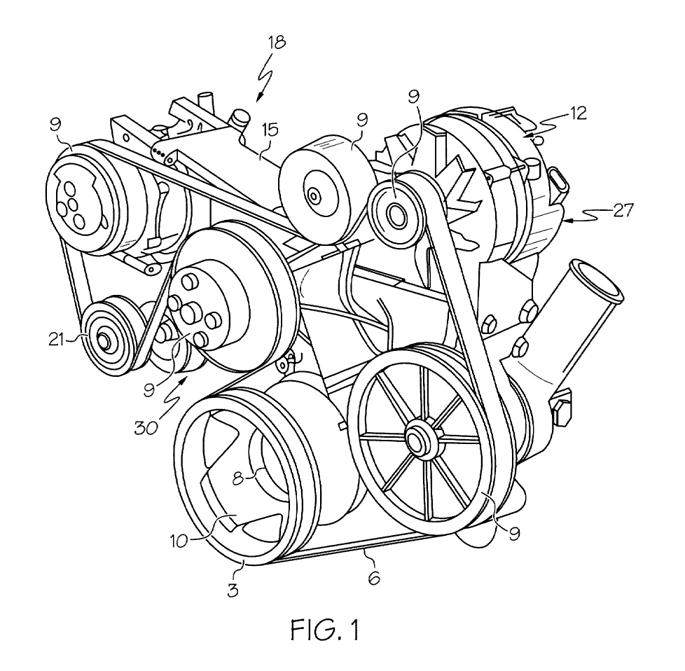

Referring now to FIG. 1, an example of one embodiment of an FEAD system 18 is shown, merely for illustration purposes, that includes an integrated housing 15, having a front surface 30 and a rear surface 27. The rear surface 27 of the integrated housing 15 is preferably mounted to an engine. The FEAD system 18 may be utilized with any engine, including vehicle, marine and stationary engines. The shape and configuration of the integrated housing 15 depends upon the vehicle engine to which it is to be mounted. Accordingly, the integrated housing 15, and more specifically the FEAD system 18, may vary along with the location of engine drive accessories 9 and still achieve the objects of the present invention. It should be understood that the location and number of engine drive accessories 9 may be varied. For example, a vacuum pump, a fuel injection pump, an oil pump, a water pump, a power steering pump, an air conditioning pump, and a cam drive are examples of other engine drive accessories 9 that may be mounted on the integrated housing 15, for incorporation into the FEAD system 18. The engine drive accessories 9 are preferably mounted to the integrated housing 15 by bolts or the like at locations along the surface that are tool accessible for easy mounting and also service accessible. In FIG. 1, the integrated housing 15 has a plurality of engine drive accessories 9, including an alternator 12 and a belt tensioner 21. The FEAD system 18 may also include one or more idler pulleys 14.

The engine drive accessories 9 are driven by at least one endless drive belt 6, which may be a flat belt, a rounded belt, a V-belt, a multi-groove belt, a ribbed belt, etc., or a combination of the aforementioned belts, being single or double sided. The endless drive belt 6 may be a serpentine belt. The endless drive belt 6 may be wound around the engine drive accessories 9, the alternator 12, the idler pulley(s) 14, the belt tensioner 21, and the drive pulley 3, which is connected to the nose 10 of the crankshaft 8. The crankshaft drives the drive pulley 3 and thereby drives the endless drive belt 6, which in turn drives the remaining engine drive accessories 9 and the alternator 12. The belt tensioner 21 automatically adjusts the tension of the endless drive belt 6 to keep it tight during operation and also prevent wear, and the idler pulley(s) 14 alter the path of the endless drive belt 6 through the FEAD system 18.

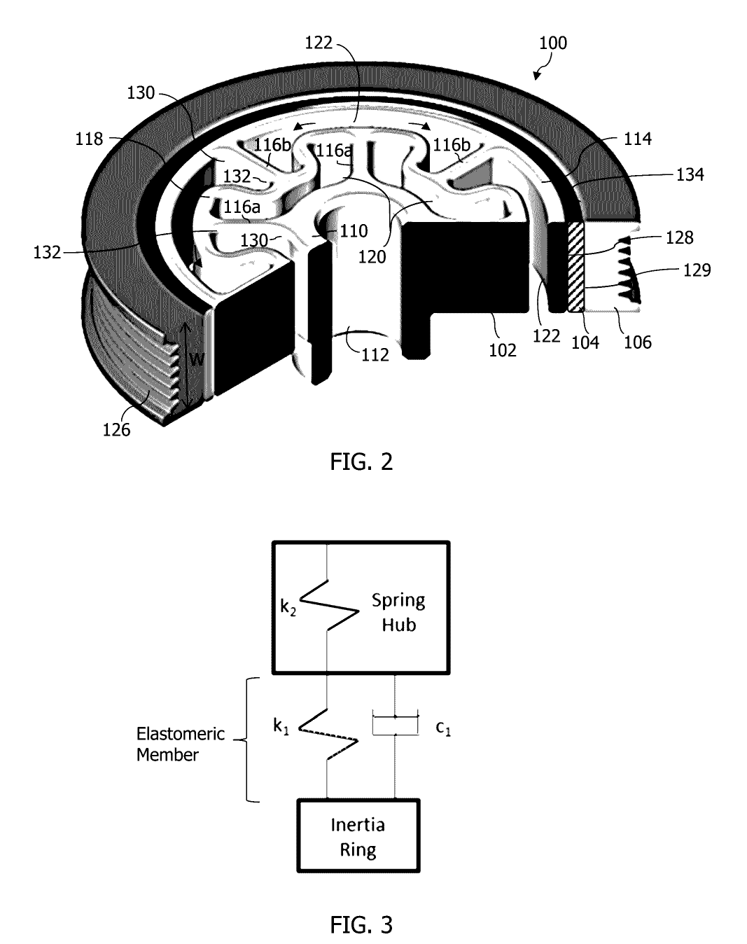

Referring now to FIG. 2, the improvement to the FEAD system 18 is a torsional vibration damper, generally designated by reference 100, that shares the load to attenuate vibrations between two springs, a metallic spring provided by the configuration of the hub 102 and an elastomer spring provided by the elastomeric member 104, which operatively couples an inertia member 106 to the hub 102 for rotation together. The hub 102 performs as a spring in series with the elastomer spring (elastomeric member 104) to absorb the vibratory energy of a shaft. In one embodiment, the shaft may be a crankshaft of an engine. The elastomeric member 104 is beneficial as it is utilized to tune the system to provide a desired amount of damping, and, in this system, the thickness of the elastomeric member can be minimized an amount equivalent to the spring damping provided by the hub 102, which provides a cost savings on material. The elastomeric member has a thickness of about 2 mm to about 10 mm, more preferably about 3 mm to about 8 mm. The two springs are in series as schematically illustrated in FIG. 3, the hub with flexible spokes (“Spring Hub”) has a spring rate k₂ and the elastomeric member has a spring rate k₁, and it is the elastomeric member's k₁ that governs the equivalent spring rate (k_{eq}). Springs in series _{eq} are determined by the equation:

k_{eq}=(k₁*k₂)/(k₁+k₂). (I)

In one embodiment, k₁ for the elastomeric member is 200 and k₂ for the spring hub is 20,000, and k_{eq} equals 198. The equivalent spring rate is more closely proximate in value to the elastomeric member than to the spring hub; thus, the elastomeric member 104 governs k_{eq}.

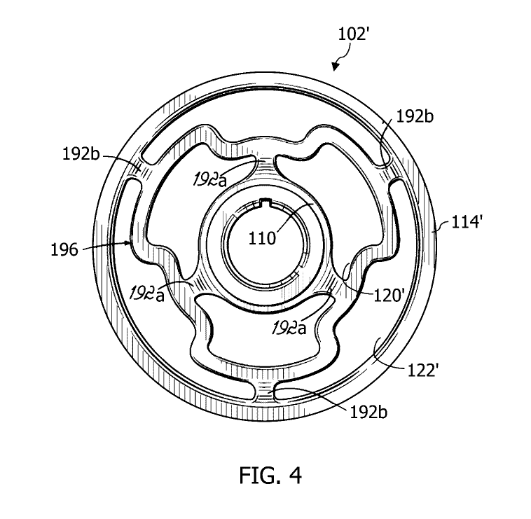

As shown in FIG. 2, the hub 102 has an innermost sleeve 110 that defines a bore 112 through the hub 102 for receiving a shaft (not shown), an outermost ring 114 concentric with and spaced radially outward from the innermost sleeve 110, and a plurality of spokes 116 connecting the innermost sleeve 110 to the outermost ring 114, the plurality of spokes 116 each having torsional flexibility to act as a first spring to absorb torsional vibrations (see arrows in FIG. 2). The plurality of spokes 116 comprise a plurality of first partial spokes 116a extending radially outward from the innermost sleeve 110 toward the outermost ring 114 and a plurality of partial spokes 116b extending radially inward from the outermost ring 114 toward the innermost sleeve 110, and are connected to one another by a continuous serpentine web 118. The serpentine web 118 defines a plurality of inner and outer labyrinth windows 120, 122, respectively, axially through the hub 102. The embodiment illustrated in FIG. 2 has four first partial spokes 116a and four second partial spokes 116b. The number of partial spokes is not limited thereto and can be any number of spokes that provide the torsional flexibility desired for a selected system. For example, in the embodiment illustrated in FIG. 4, three first partial spokes 192a and three second partial spokes 192b connected by a serpentine web 196 are shown as a possibility.

In each of these embodiments, the partial spokes extend radially toward either the innermost sleeve 110, 110′ or the outermost ring 114, 114′, but not all the way thereto. Each of the partial spokes may extend greater than half the distance, half the distance, or less than half the distance toward either of the innermost sleeve, 110, 110′ and outermost ring 114, 114′ as the case may be. FIG. 2 depicts a plurality of partial spokes 116 that extend greater than half the distance, but not all the way to the opposing ring or sleeve. FIG. 4 depicts a plurality of partial spokes 192 that extend less than half the distance to the opposing sleeve or ring 110′, 114′.

As illustrated in FIGS. 2 and 4, the serpentine web 118, 196 extends, first, generally radially outward from a second end 132 of each spoke 116, 192, opposite a first end 130 that is connected to either the innermost sleeve 110, 110′ or the outermost ring 114, 114′, on either side thereof to form a generally T-shaped member. From the T-shaped member, the web 118, 196 extends, secondly, generally radially to connect adjacently, neighboring T-shaped members together into a continuous serpentine web connecting sequentially all of the inner and outer partial spokes 116, 192. The T-shaped members flex to counter vibration; in particular, they enable the inertia ring to oscillate at the same frequency, but exactly opposite phase, with respect to the exciting vibration of the shaft.

The hubs 102, 102′ of FIGS. 2 and 4, including the spokes and the serpentine web, are formed from metal. Any metal suitable for torsional vibration dampers is possible, including but not limited to steel, ductile iron, grey iron and aluminum, as well as composites containing a metal, as long as the material can provide the requisite torsional flexibility.

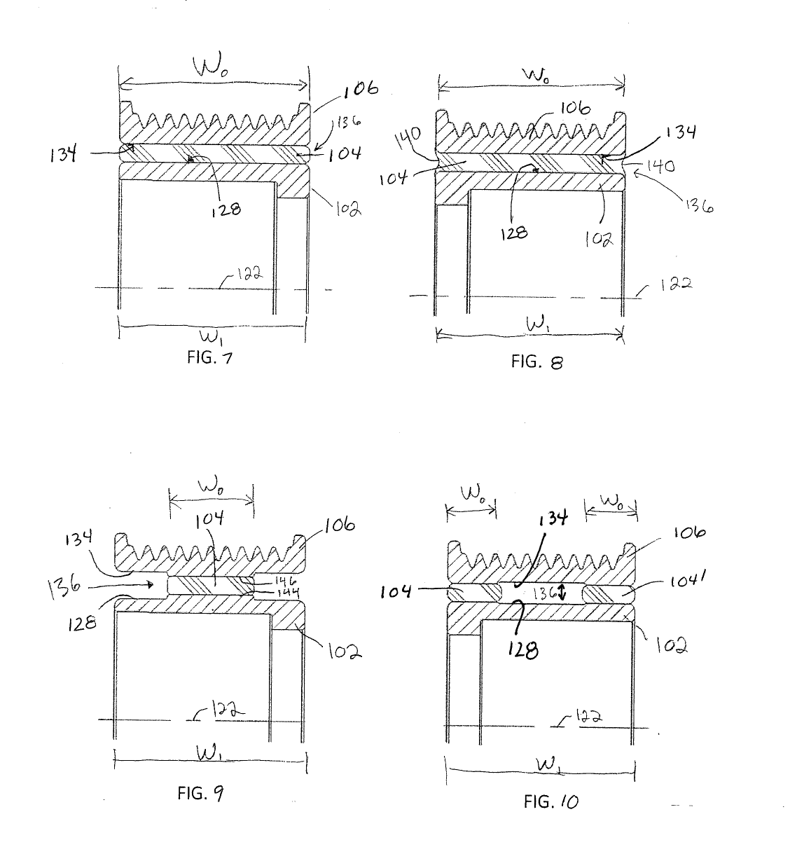

The elastomeric member 104 is an annular ring positioned concentric with and in contact with a radial outermost surface 128, 128′ of the outermost ring 114, 114′ of the hubs 102, 102′. As noted above, the elastomeric member 104 is acting as a second spring to damp torsional vibrations. The elastomeric member 104 also operatively couples an inertia member 106 to the hub 102. As shown in FIG. 2, the inertia member 106 is an annular ring seated concentrically against a radial outermost surface 129 of the elastomeric member 104 as shown in FIG. 2. The elastomeric member 104 is a single annular member that may be press fit or injected into a gap between the inertia member 106 and the radial outermost surface 128 of the hub 102. The elastomeric member 104 may take a variety of other forms, including discrete dual annular rings seated on or recessed into at least one of the inertia member 106 or the radial outermost surface 128 of the hub as shown and described in more detail below with respect to FIGS. 7-14.

Referring now to FIG. 7, a single elastomeric member 104 may be positioned in the gap between the hub 102 and the inertia member 106, and the elastomeric member may have a width W₀ that is substantially similar to a width W₁ of the radial outermost surface 128 of the hub 102 or the radial inner surface 134 of the inertia member 106. In the embodiment shown in FIG. 7, the elastomeric member 104 is inserted between the hub 102 and the inertia member 106, such as by press-fitting or the like, or post-bonded to the hub 102 and/or the inertia member 106. FIG. 8 shows the single elastomeric member 104 having width W₀ substantially the same as the width W₁ of the radial outermost surface 128 of the hub 102 or the radial inner surface 134 of the inertia member 106; however, the elastomeric member 104 is molded into the gap 136 between the hub 102 and the inertia member 106, and as a result axial shrinkage occurs at the axially outermost surfaces 140 of the elastomeric member 104.

Referring to FIG. 9, the elastomeric member 104 may be a single elastomeric member having a width W₀ that is less than the width W₁ of the radial outermost surface 128 of the hub 102 or the radial inner surface 134 of the inertia member 106. The radial outermost surface 128 of the hub 102 may have an outer engaging portion 144 protruding radially outward therefrom upon which the elastomeric member 104 is seated. The radial inner surface 134 of the inertia member 106, likewise or as an alternative to the radial outermost surface 128, may have an inner engaging portion 146 protruding radially inward from the radial inner surface 134 upon which an opposing side of the elastomeric member 104 is seated in compression to operatively couple the inertia member 106 to the hub for rotation together.

Referring to FIG. 10, the torsional vibration damper 100 may include a plurality of elastomeric members 104, 104′ positioned in the gap 136 between the hub 102 and the inertia member 106. Each of the elastomeric members 104, 104′ has a width W₀ that is less than the width W₁ of the radial outermost surface 128 of the hub 102 or the radial inner surface 134 of the inertia member 106. Although FIG. 10 shows two elastomeric members 104, 104′, it is understood that more than two elastomeric members may be utilized. The elastomeric members 104, 104′ may be annular and may be spaced a distance apart in an axial direction from one another or may abut against an adjacent elastomeric member. The elastomeric members may also be a plurality of discrete pieces, which may be spaced apart, evenly or otherwise, in either or both of the axial and angular directions.

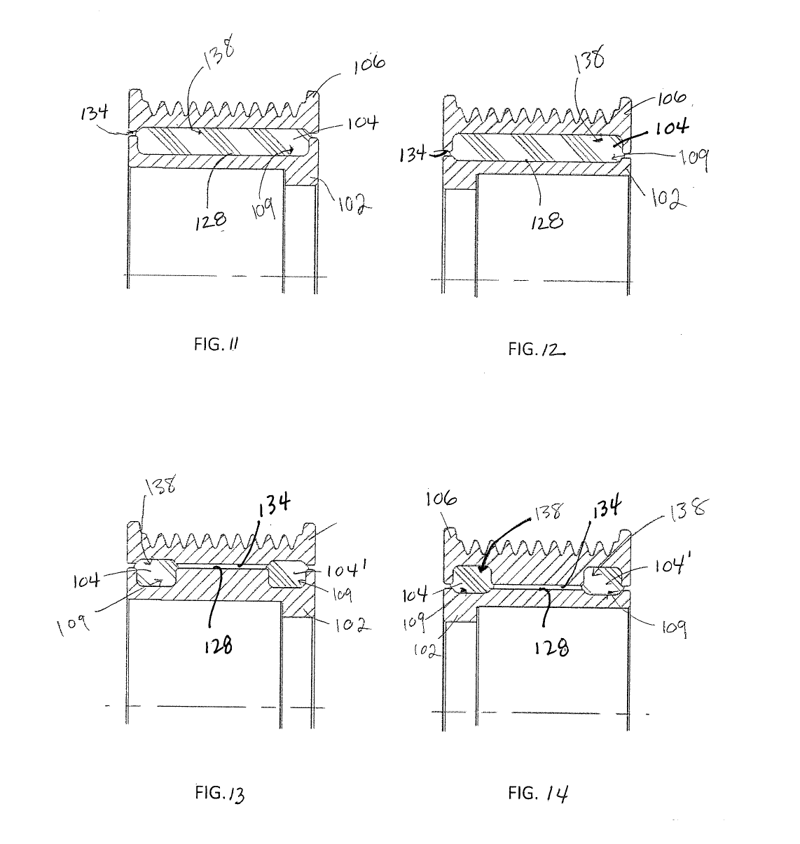

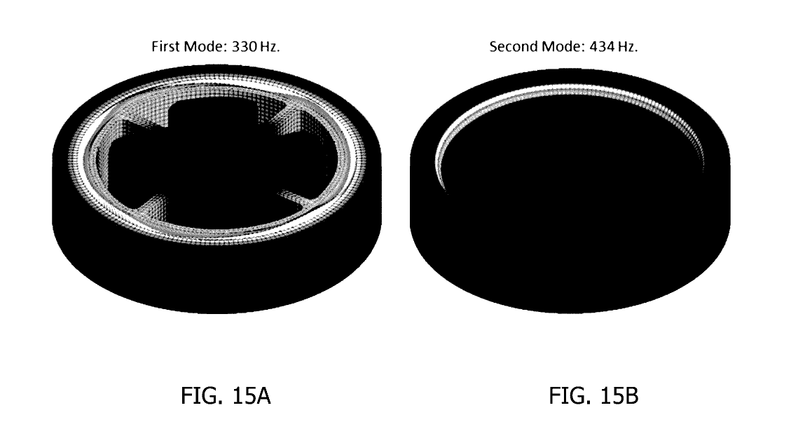

Referring now to FIGS. 11-14, embodiments are illustrated that include the radial outermost surface 128 of the hub 102 defining one or more hub recesses 109 and the radial inner surface 134 of the inertia member defining one or more inertia member recesses 138. FIGS. 11-12 illustrate a single elastomeric member 104 positioned with a portion of the elastomeric member 104 seated in the hub recess 109 and another portion of the elastomeric member 104 seated in the inertia member recess 138. In FIG. 11, the hub recess 109 is deeper than the inertia member recess 138 so that a larger portion of the elastomeric member 104 is seated within the hub recess 109. In FIG. 12, the inertia member recess 138 is deeper than the hub recess 109, resulting in a larger portion of the elastomeric member 104 being seated within the inertia member recess 138.

FIGS. 13-14 illustrate embodiments similar to those depicted in FIGS. 11-12, except with a plurality of elastomeric members 104, 104′ seated between the hub 102 and the inertia member 106, with both of the elastomeric members 104, 104′ seated in the respective recesses 109, 138. Although only two elastomeric members are shown, it is understood that more than two elastomeric members may be utilized. In FIG. 13, the hub recesses 109 are deeper than the inertia member recesses 138 so that a larger portion of the elastomeric members 104, 104′ is seated within the hub recesses 109. In FIG. 14, the inertia member recesses 138 are deeper than the hub recesses 109, resulting in a larger portion of the elastomeric members 104, 104′ being seated within the inertia member recesses 138.

The elastomeric member may be any elastomer material suitable to absorb and/or dampen torsional vibrations, as the case may be, generated by a rotating shaft upon which the torsional vibration damper 100 is mounted. The elastomeric members can be formed by extrusion compression, transfer or injection molding. The elastomer material is preferably one suitable for automotive engine applications, i.e., suitable to withstand temperatures experienced in the engine and road temperatures and conditions. The elastomer material may be as disclosed in U.S. Pat. No. 7,658,127, which is incorporated herein, in its entirety, by reference. In one embodiment, the elastomeric members may be made from or include one or more of a styrene-butadiene rubber, a natural rubber, a nitrile butadiene rubber, an ethylene propylene diene rubber (EPDM), an ethylene acrylic elastomer, a hydrogenated nitrile butadiene rubber, and a polycholoroprene rubber. One example of an ethylene acrylic elastomer is VAMAC® ethylene acrylic elastomer from E. I. du Pont de Nemours and Company. The elastomeric member may be a composite material that optionally includes a plurality of fibers dispersed therein. The fibers may be continuous or fragmented (chopped) aramid fiber like the fiber sold under the name TECHNORA® fiber. In one embodiment, the elastomer damper member 120 may be attached to the outer annular ring 106 using a conventional adhesive known for use in vibration damping systems. Some examples of suitable adhesives include rubber bonding adhesives sold by the Lord Corporation, Henkel AG & Co., or Morton International Incorporated Adhesives & Specialty Company.

A torsional vibration damper is designed to absorb vibration in a defined frequency range within permitted space limitations for a selected system. The thickness of the overall torsional vibration damper, the total mass of the inertia mass, as well as its total inertia, and design of the plurality of flexible spokes, the design of the serpentine web when present, elastomer material, and thickness of the elastomer material can all be varied to achieve an amount of dampening desired for the selected system. In a typical automotive application, a torsional vibration damper can have a diameter of about 100 mm to about 200 mm and a width of about 20 mm to about 60 mm. The general inertia requirements may vary widely and can be anywhere from about 2000 kg·mm²to about 50,000 kg·mm².

The hub 102 of the torsional vibration damper 100, which includes the innermost sleeve, outermost ring, spokes, and connecting member (serpentine web in some embodiments), is a monolithic body, which can be formed by a variety of methods. The hub can be extruded, cast, cast and subsequently machined, shell molded, or completely machined, just to name a few non-limiting examples.

The inertia member 106 can be made from any material having a sufficient inertia, usually cast iron, steel, or similar dense material, formed by a variety of methods. The inertia member can be extruded, cast, cast and subsequently machined, shell molded, or completely machined, just to name a few non-limiting examples.

A second alternate embodiment of a hub 202 is shown in FIG. 4. In this embodiment, the hub 202 includes an innermost sleeve 210 defining a bore 212 for receiving a shaft, an outermost ring 214, a first intermediate ring 256, and a second intermediate ring 258. The innermost sleeve 210 is connected to the first intermediate ring 256 by three spokes 260. Likewise, the first intermediate ring 256 is connected to the second intermediate ring 258 by three spokes 262, and the outermost ring 214 is connected to the second intermediate ring 258 by three spokes 264. Here, the partial spokes are interconnected by annular rings, i.e., first intermediate ring 256 and second intermediate ring 258, rather than a serpentine web.

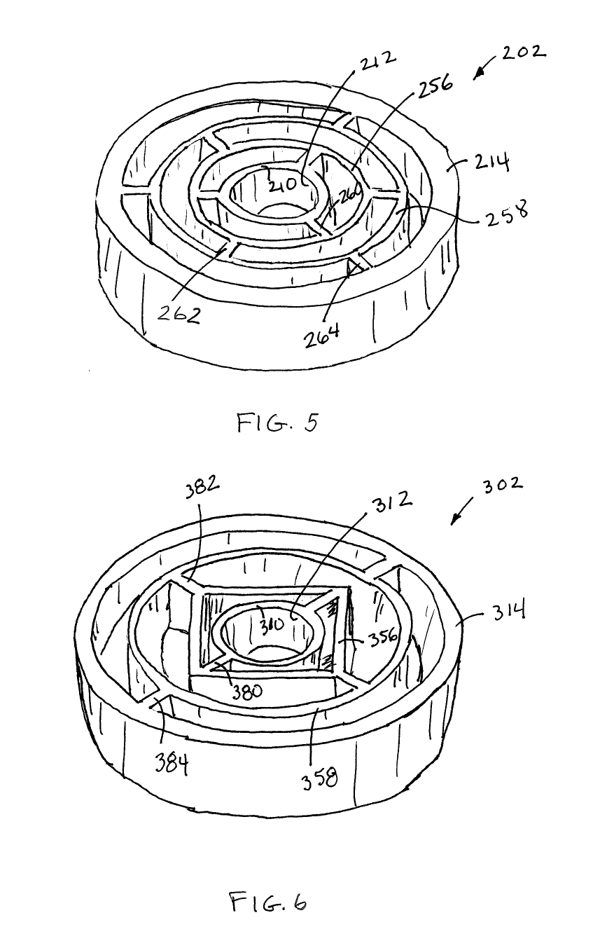

FIG. 5 shows another alternate embodiment for the hub, labeled as hub 302. Hub 302 includes an innermost sleeve 310 defining a bore 312 for receiving a shaft, an outermost ring 314, a first intermediate ring 356, and a second intermediate ring 358. Instead of being an annular ring, first intermediate ring 356 is a rectangular member surrounding the innermost sleeve 310 and is connected to the innermost sleeve 310 by two spokes 380. The first intermediate rectangular member 356, in turn, is attached to the second intermediate ring 358 by two spokes 382, and the second intermediate ring 358 is attached to the outermost ring 314 by two spokes 384.

The various embodiments for the configuration of the spokes illustrate that numerous constructions and geometries are possible that provide the hub with torsional flexibility. In each of the embodiments of the hub having flexible spokes with torsional flexibility, regardless of the number present, the spokes extending from the same surface are typically spaced apart equidistant, for example 180 degrees if two spokes are present, 120 degrees if three spokes are present, etc. With respect to the torsional flexibility of the hub, the torsional flexibility is such that about 5% to about 75% of k_{eq} is provided by the hub.

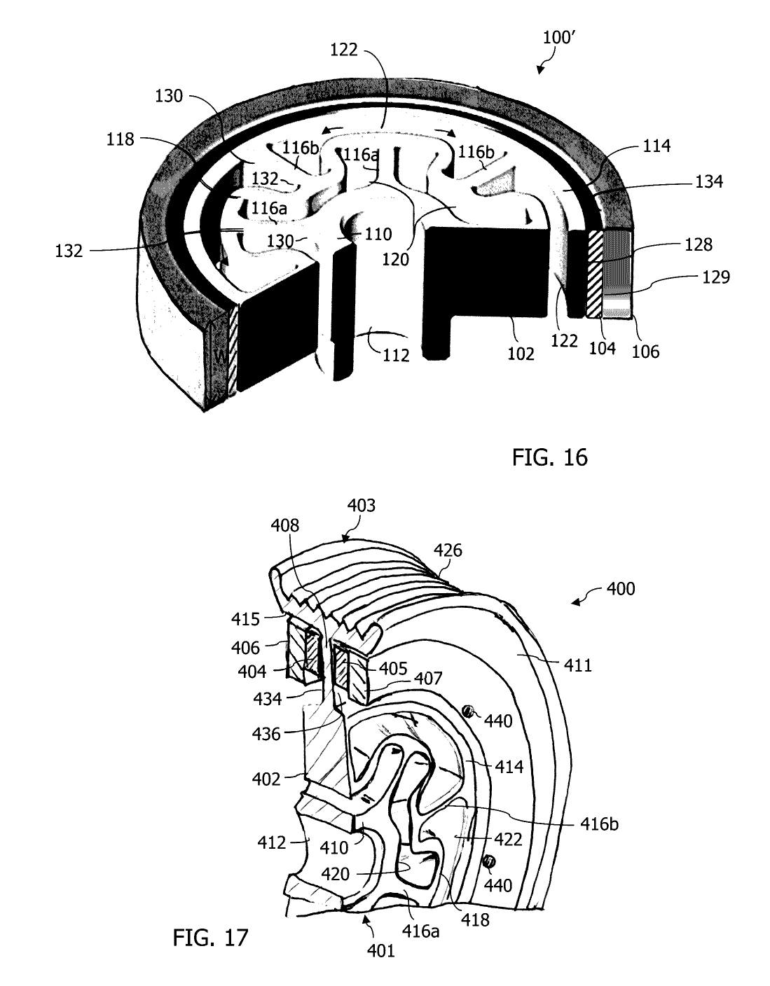

Turning now to FIG. 16, a driveline torsional vibration damper 100′ is shown, which has the same features as the torsional vibration damper of FIG. 2, except that there is no belt engaging surface on the inertia member 106.

For both of the embodiments illustrated in FIGS. 2 and 16, reverse configurations are also possible in which the inertia member is disposed concentric with and spaced radially inward from the hub, i.e., the inertia member is inside the innermost sleeve of the hub with the elastomeric member operably coupling the inertia member to the hub. In this embodiment, the hub is mountable inside a shaft rather than on a shaft, to attenuate torsional vibrations by being seated against the inner surface of the shaft. Otherwise, the features, in particular the plurality of spokes of the hub being in series with the elastomeric member, are unchanged.

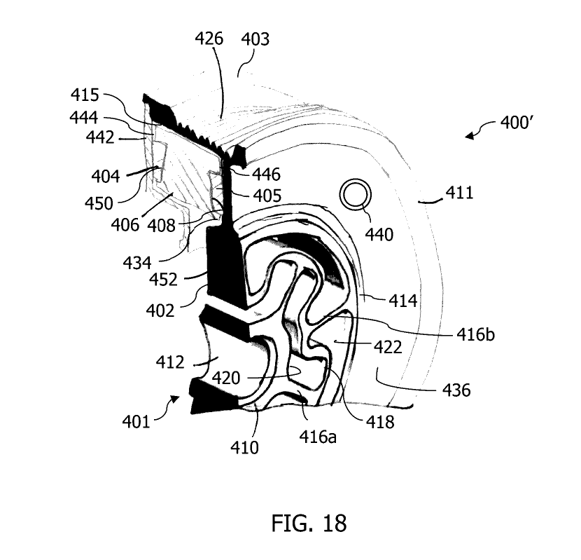

Referring now to FIGS. 17 and 18, two embodiments of a direct drive style torsional vibration damper 400, 400′ are shown that each have a hub portion 402 similar to hub 102, described above, that acts as a first spring in series with a plurality of second springs 404, 405. Here, the torsional vibration dampers 400, 400′ have a pulley-hub monolithic member 401 having a hub portion 402, a pulley portion 403, and one or more inertia members 406, 407 fixedly or removably attached to one or more generally parallel congruent faces 434, 436 of the pulley portion 403, each with an elastomeric member 404, 405 therebetween to dampen and/or absorb (i.e., attenuate) the vibrational frequencies of a rotating member, such as a crankshaft. The pulley-hub monolithic member 401 provides for a “direct” drive system, i.e., one where the endless belt rides on the belt engaging surface 426 of the hub. This is in contrast to an “indirect” drive system, such as in FIG. 2 where the endless belt rides the inertia member which is indirectly coupled to the hub and is tuned to oscillate with an enhanced magnitude that is out of phase relative to the angular amplitude of vibration of the hub/crankshaft.

In FIG. 17, the elastomeric members 404, 405 and the inertia members 406, 407 are disposed adjacent to the back side 415 of the outer belt-engaging surface 426 of the pulley portion 403 and the inertia members 406, 407 hold the elastomeric members 404, 405, respectively in compression against the pulley portion 403, in particular against the plate 408 extending between the hub portion 402 and the belt engaging surface 426. These components are operatively coupled together by the fasteners 440 for rotation together with no relative rotation of any components and no translation of any component relative to another component.

The hub portion 402 defines the axis of rotation for the torsional vibration dampers 400, 400′ and has a bore 412 therethrough configured to receive and be coupled to a shaft for rotational movement therewith. The pulley portion 403 includes plate 408 extending radially outward about the hub portion 402 and an annular ring 411 having the outer belt engaging surface 426 forming the outer-most side of the plate 408. The plate 408 may include a plurality of apertures each defining a hole for one of the fasteners 440. The belt engaging surface 426 may be flat, contoured to receive a rounded belt, or have V-grooves for mating with the V-ribs of a V-ribbed belt or any other required contoured groove to mate with an endless belt.

The innermost sleeve 410 of the hub portion 402 may extend axially in one direction from the plate 408, thereby defining the back face of the torsional vibration damper 400, which is mounted onto a crankshaft facing the engine. Opposite thereof, surface 434 of the plate 408 defines the front face, which will receive the nose seal 10 (FIG. 1) fastening the torsional vibration damper 400 to a shaft for rotation therewith.

As shown in FIGS. 17 and 18, the hub portion 402 has an innermost sleeve 410 that defines a bore 412, an outermost ring 414 concentric with and spaced radially outward from the innermost sleeve 410, and a plurality of spokes 416 connecting the innermost sleeve 410 to the outermost ring 414. The plurality of spokes 416 each have torsional flexibility to act as a first spring to absorb torsional vibrations (see arrows in FIG. 2). The plurality of spokes 416 comprise a plurality of first partial spokes 416a extending radially outward from the innermost sleeve 410 toward the outermost ring 414 and a plurality of partial spokes 416b extending radially inward from the outermost ring 414 toward the innermost sleeve 410, and are connected to one another by a continuous serpentine web 418. The serpentine web 418 defines a plurality of inner and outer labyrinth windows 420, 422, respectively, axially through the hub portion 402. The partial spokes are as described above with respect to the other embodiments, and the number thereof is not limited so long as they provide the torsional flexibility desired for a selected system. Likewise, the serpentine web 418 is as described above for the other embodiments.

The pulley-hub monolithic member 401 may be cast, spun, forged, machined, or molded using known or hereinafter developed techniques. Suitable material for the pulley-hub monolithic member 401 includes iron, steel, aluminum, other suitable metals, plastics, or a combination thereof, including composite materials. The first and second elastomeric members 404, 405 and the first and second inertia members 405, 407 may be made of the materials discussed above with respect to the embodiment of FIG. 2, and may have beveled faces on one or both major surfaces thereof as disclosed in copending, published U.S. Application 2015/0252885.

Turning now to FIG. 18, the torsional vibration damper 400′ differs from the one in FIG. 17 in the positioning of the elastomeric members 404, 405 both on one side of the plate 408 such that only one inertia member 406 is needed. From left to right, relative to the orientation of the drawing on the page, the torsional vibration damper 400′ includes a front end cap 442, a first elastomeric member 404, an inertia member 406, a second elastomeric member 405, and a pulley-hub monolithic member 401. These components are operatively coupled together by the fasteners 440 (one of which is shown in the drawing) for rotation together. The torsional vibration damper 400′ may also include, still moving from left to right, an optional tone wheel (not shown) attached to the pulley-body monolithic member 401 for rotation therewith. There is no relative rotation of any components and no translation of any components relative to another component. Otherwise, the TVD 400′ includes the same features as discussed above with respect to FIG. 17 and with respect to FIG. 2 for the hub portion 402.

Still referring to FIG. 18, the inertia member 406 is an annular body having opposing front and back surfaces 444, 446 and may be made from any material having a sufficient mass, usually a cast iron metal. The front surface 444 may be beveled for at least the portion against which is seated the first elastomeric member 404 or it may be straight, i.e., generally perpendicular to the axis of rotation as disclosed in copending, published U.S. Application 2015/0252885. Likewise, the back surface 446 of the inertia member 406 may also be beveled or straight for mating against the second elastomeric member 405. Moreover, the inertia member 406 may include a first annular groove 450 in the front surface 444 as a receptacle for at least a portion of the first elastomeric member 404 and a second annular groove 452 in the back surface 446 as a receptacle for at least a portion of the second elastomeric member 405.

Either or both of the first and second elastomeric members 404, 405 may have a trapezoidal geometry in cross-section once assembled as shown in FIG. 18. Here, the first elastomeric member 404 is compressed between the plate 408 and the front end cap 442 and the inertia member 406 wherein one or both thereof may have an angled face mated against the first elastomeric member. Similarly, the second elastomeric member 405 is compressed against one or more angled faces, but those faces are of the inertia member 406 and the plate 408.

The front end cap 442 is fixedly or removably attachable to the pulley-hub monolithic member 401 by fasteners or other methods. The fasteners may be bolts, screws, rivets, or the like. In another embodiment, the front end cap 442 may be connected to the pulley-hub monolithic member 401 by roll or orbit forming, a press-fit connection, or welded thereto. As seen in FIG. 18, the front end cap 442, in this embodiment, is instrumental in compressing the first and second elastomeric members 404, 405 and in maintaining the assembly of the components of the torsional vibration damper 400′.

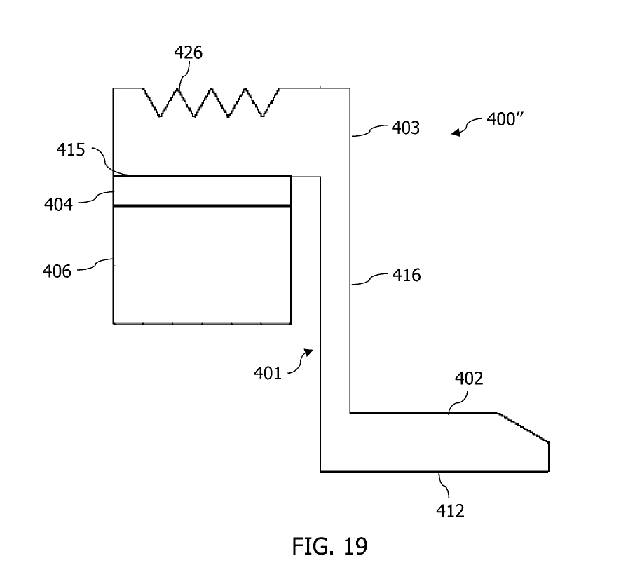

Referring now to FIG. 19, a simpler direct drive torsional vibration damper 400″ is illustrated that has a pulley-hub monolithic body 401 that has a pulley portion 403 with a belt engaging surface 426 and has a hub portion 402 having a spoke region 416 comprising a plurality of partial spokes, as described above for the various embodiments, that have torsional flexibility such that the hub acts as a first spring. The pulley-body portion 403 has a back side 415 opposite the belt engaging surface 426 upon which is seated the elastomeric member 404, which operatively couples the inertia member 406 to the back side 415 of the pulley portion 403 for rotation therewith and acts as a second spring in series with the first spring to attenuate torsional vibrations in a rotating shaft. The hub portion 402 defines a bore 412 configured to receive a shaft.

It will be appreciated that while the invention has been described in detail and with reference to specific embodiments, numerous modifications and variations are possible without departing from the spirit and scope of the invention as defined by the following claims.

What is claimed is:

1. A torsional vibration damper for a rotating shaft comprising:
a hub configured for connection to a rotating shaft, the hub having a plurality of spokes that have torsional flexibility to act as a first spring to attenuate torsional vibrations; and
an inertia member operatively coupled to the hub for rotation therewith by an elastomeric member that acts as a second spring to attenuate torsional vibrations;
wherein the first spring and the second spring are in series.

2. The torsional vibration damper of claim 1, wherein the elastomeric member is positioned concentrically against a radially outermost surface of the hub with the inertia member radially concentric about the elastomeric member or concentrically against a radially innermost surface of the hub with the inertia member radially concentric inward of the elastomeric member.

3. The torsional vibration damper of claim 1, wherein the equivalent spring rate (k_{eq}) for the first and second springs in series is governed by the elastomeric member.

4. The torsional vibration damper of claim 3, wherein the elastomeric member has a thickness of about 2 mm to about 10 mm.

5. The torsional vibration damper of claim 1, wherein the plurality of spokes define a plurality of labyrinth windows axially through the hub.

6. The torsional vibration damper of claim 1, wherein the plurality of spokes comprise a plurality of first partial spokes extending radially outward from an innermost sleeve of the hub and a plurality of partial spokes extending radially inward from an outermost ring of the hub, and are connected to one another by a continuous serpentine web.

7. The torsional vibration damper of claim 1, wherein the inertia member has an outermost belt-engaging surface, and the bore of the hub is configured to receive a crankshaft.

8. The torsional vibration damper of claim 1 wherein the hub is part of a pulley-hub monolithic body comprising a belt engaging surface on the radially outermost surface of the pulley portion thereof.

9. The torsional vibration damper of claim 8, wherein the inertia member is operatively coupled to a back side of the pulley portion opposite the belt engaging surface placing the elastomeric member in compression radially.

10. The torsional vibration damper of claim 8, wherein the inertia member is axially positioned to axially compress the elastomeric member against the pulley-hub monolithic body.

11. The torsional vibration damper of claim 1, wherein the plurality of spokes comprise a first plurality of partial spokes extending from an innermost sleeve toward an outermost ring of the hub.

12. The torsional vibration damper of claim 11, wherein the first plurality of partial spokes each comprise a generally T-shaped member interconnected to one another by a generally annular connecting member.

13. The torsional vibration damper of claim 12, wherein the plurality of spokes further comprise a second plurality of partial spokes extending from the outermost ring toward the innermost sleeve.

14. The torsional vibration damper of claim 13, wherein the second plurality of partial spokes are each a generally T-shaped member interconnected with the T-shaped members of the first plurality of partial spokes by the generally annular connecting member.

15. The torsional vibration damper of claim 1, wherein the hub and the inertia member include opposing annular recesses in which the elastomer is seated.

16. The torsional vibration damper of claim 15, wherein one of the annular recesses is deeper than the other.

17. The torsional vibration damper of claim 1, wherein the elastomeric member is press-fit between the hub and the inertia member or is mold bonded to one of the hub or inertia member.

18. The torsional vibration damper of claim 1, wherein the elastomeric member comprises a plurality of elastomeric members each having a first width that is less and a second width of the radial outermost surface of the hub, concentric about an axis of rotation of the hub and positioned a distance apart in an axial direction from one another or abutting against an adjacent elastomeric member.

19. The torsional vibration damper of claim 1, wherein the hub is configured to couple to a driveline shaft.

20. A front end accessory drive system comprising the torsional vibration damper of claim 1.
